(19) United States
(12) Patent Application Publication
(10) Pub. No.: US 2005/0140094 A1
(43) Pub. Date: Jun. 30, 2005

(54) Relating to seals

(76) Inventors: Ross Strachen Parker, Warrington (GB); Michael Bradley, Warrington (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/508,502

(22) PCT Filed: Mar. 21, 2003
(86) PCT No.: PCT/GB03/01228

(30) Foreign Application Priority Data
Mar. 25, 2002 (GB) 0206958.1

(51) Int. Cl. F16J 15/16

(52) U.S. Cl. 277/500

(57) ABSTRACT

Problems with maintaining the effectiveness of the seal whilst passing containers into contained locations, due to the different sizes of containers which need to be passed through, are addressed by a seal assembly that includes a housing which defines a through bore. One or more seals are provided in the bore. One or more of the seals includes a support frame, an element extending at least from the inner edge of the support frame to the boundary of a through aperture, and one or more resiliently deformable members at least partially surrounds the aperture in the element, and which engages with the element.

The present invention concerns improvements in and relating to seals, in particular sphincter seals designed to prevent the egress/release of dangerous or harmful substances.

Sphincter seal arrangements allow containers to be introduced into glove boxes or other locations without breaching containment. Known arrangements simply comprise rings of flexible material placed in series within a housing. The rings are designed to have a bore slightly smaller than the common diameter of all the objects that are placed into the glove box. Typically, the glove boxes are holding hazardous materials for example radioactive matter/material or toxic chemical substances and it is therefore imperative that no contamination which could be harmful to the user or be a hazard in the immediate working area is allowed to escape from the glove box.

In these known arrangements outward contamination is prevented by more than one of the flexible rings sealing around the outside of the object passed through the sphincter seal. In order to escape, contamination would have to pass through several separate seals. New containers are introduced into the glove box by pushing a new container into the sphincter seal. This pushes the container previously present in the sphincter seal into the glove box. Intermittently, new seals are added from the outside of the box, the used seals adjacent the glove box being allowed to fall into the glove box.

However, the aforementioned existing seals have several limitations. Firstly, the seals are only designed to allow the passage of a single diameter of container. The seals are insufficiently flexible to allow containers to pass through which have substantially similar diameters. Thus, cans with diameters which differ by around 1 inch (2.54 cm) cannot be passed through the seal whilst maintaining the integrity of the seal. Furthermore, in the existing design a support frame is provided in the form of a series of rings of fixed diameter, aligned with the axis of the seal, which generally match the container in diameter and hence support the container whilst it is within the seal. Its position is maintained as a result, failing which the seal is unduly deformed out of position by the containers weight and the integrity of the seal is lost. Such a supporting structure is not possible for containers which vary in diameter from one case to the next.

Amongst the objects of the present invention is to provide a more versatile seal, particularly a seal which can allow varying diameter containers to pass through without detracting from the integrity of the seal. Amongst the objects of the invention is to provide an improved sphincter seal. Amongst the objects of the present invention is to provide a seal which supports the weight of a container passing through it without detracting from the integrity of the seal.

According to a first aspect of the present invention, there is provided a seal assembly including a housing which defines a through bore, one or more seals being provided in the bore, one or more of the seals including a support frame, an element extending at least from the inner edge of the support frame to the boundary of a through aperture and one or more resiliently deformable members which at least partially surrounds the aperture in the element and which engages with the element.

The resilient nature of the member enables snug engagement with the outer surface of objects passed through the seal assembly by the element. This allowing objects of different diameters or objects of varying diameter to be passed through the seal assembly without the risk of the egress of contaminated material in an associated glove box, for instance. The support provided by the resiliently deformable members also prevents the weight of the object from distorting the lower portion of the seal and thereby reduces the risk of the egress of contaminated material from an associated glove box. This is achieved without the need for any further sealing elements such as “O” rings between the seal and the housing.

Preferably the seal assembly is provided between a clean environment and a contaminated environment. Preferably the through bore extends between the two. Preferably the seal assembly includes a support frame for the housing.

The housing is preferably a cylindrical housing, ideally a right cylinder. Preferably the housing extends into the contaminated environment. Preferably the through bore is cylindrical, ideally right cylindrical. The housing may be made of any suitable durable material. Preferably, the housing is made of stainless steel.

Preferably a plurality of seals are provided in the through bore. It is preferred that between four and ten such seals be provided. Ideally seven seals are provided. The seals may be replaceable, preferably by displacing a seal from the housing into the contaminated environment. Preferably the introduction of a replacement seal causes the displacement.

Preferably a plurality and ideally all of the seals present include a support frame, an element extending at least from the inner edge of the support frame to the boundary of a through aperture and one or more resiliently deformable members which at least partially surrounds the aperture in the element and which engages with the element.

The support frame for the element preferably includes a first frame component and a second frame component. Preferably at least a part of the element is sandwiched between the first and second frame components. Preferably the first and second components are aligned by means of two or more dowels. Preferably the first and second frame components are fixed to one another using releasable fasteners, such as bolts. Preferably the first and second components are annular in shape. Preferably the outer surface of the first and second components correspond to the internal profile of the housing. Preferably the opposing surfaces of the first and second components are planar and ideally parallel to one another.

Preferably the first component of one seal abuts the second component of another seal. Preferably the second component of the one seal abuts the first component of a still further seal. A series of seals whose support frames abut one another may be provided.

Preferably the support frame or support frames are retained in the housing by a retaining plate. Preferably a retaining plate is provided on the clean environment side of the housing. The plate is preferably releasable. Preferably a retaining plate is provided on the contaminated side of the housing. Preferably the plate is also releasable.

The element is preferably flexible. The element may be formed of rubber. Preferably the element extends from the support frame, encloses the one or more resiliently deformable members and extends back to the support frame. Preferably a double thickness of the element is provided between components of the support frame. Preferably a single element is provided in each seal. Preferably the element is continuous and impermeable to solid material between the inner edge of the support frame and the through aperture in the element.

The one or more resiliently deformable members may be springs. It is preferred that a single resilient member is provided for each seal. Preferably the resilient member encloses the aperture in the element. Preferably a flexible rubber material which forms a closed loop around a spring is provided. The spring may be of any shape for example, square, hexagonal or octagonal. Conveniently, the spring is circular. The spring may be made of any suitable material. Preferably, the spring is made of spring steel.

The member and/or element may have a bore in the range of 75 mm to 175 mm in an undeformed state. The undeformed bore may be between 100 mm to 150 mm in diameter. Conveniently, the member and/or element has a bore of 125 mm in an undeformed state. Preferably, the bore can extend by more than 25 mm from the undeformed state to a flexed state.

The outer diameter of the element may be in the range of 100 mm to 300 mm. Alternatively, the outer diameter of the element may be between 150 mm and 250 mm. In certain embodiments, the outer diameter of the element may be in the region of 175 mm to 225 mm. In preferred embodiments, the element has an outer diameter of 208 mm. The dimensions may be considered in relation to the parts of the element inside the bounds of the support frame.

Any suitable rubber material may be used to make the element. Conveniently, the flexible rubber material is viton. Viton is a flexible yet tough rubber material which forms an effective seal around objects located in the seal assembly.

In preferred embodiments, a plug is inserted into the seal assembly, particularly between the passage of containers through the assembly. The plug is preferably provided in the part of the trough bore occupied by one or more of the seals. Having a plug in the seal assembly at all times when the assembly is not in use prevents contamination from an associated glove box spreading outwards.

According to a second aspect of the present invention there is provided a passage between a first environment and a second environment in which the passage is sealed using a seal assembly according to the first aspect of the invention.

Various embodiments of the invention will now be described, by way of example only, and with reference to the accompanying drawings, in which:

FIG. 1 illustrates a cross-sectional view of a sphincter seal assembly designed to facilitate the passage of a single diameter of container;

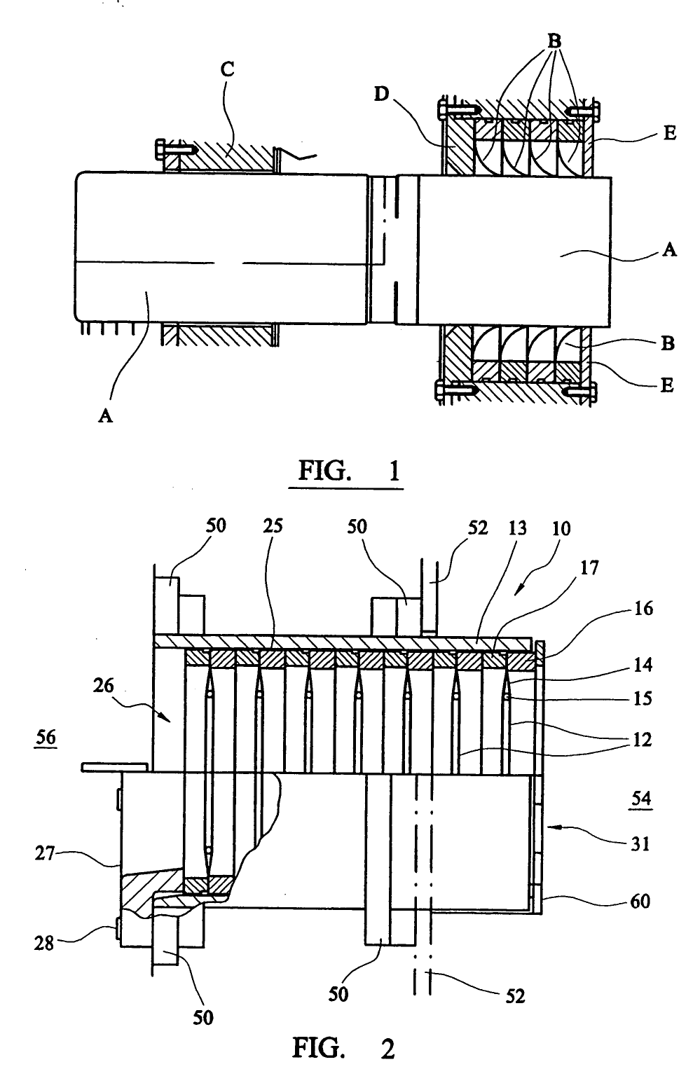

FIG. 2 illustrates a cross-sectional view of a sphincter seal assembly according to one embodiment of the invention;

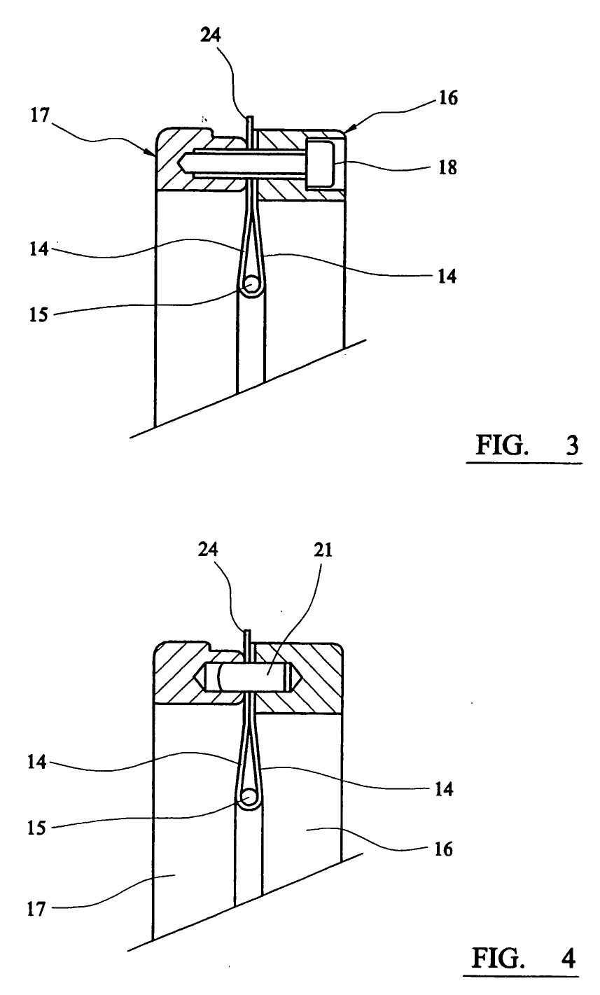

FIG. 3 illustrates a detailed cross-sectional view of a seal element showing the connection between a seal ring and a clamp ring; and

FIG. 4 illustrates a detail cross-sectional view of a seal element showing arrangement for aligning a seal ring and a clamp ring.

In the FIG. 1 design a container A is present in the seal assembly with the integrity of the seal being maintained by a series of deformable seals B which have a through bore in them which has a lower diameter than the diameter of the container A. The seals B are rubber and fairly easily deformed. To prevent the weight of the container A stretching the seals B and potentially causing gaps between the seals B and the container A, particularly at the top, a support structure is provided. The support structure is formed by concentric rings C, D and E which have an inner diameter which snugly matches the outer diameter of the container A. This support prevents the weight of the container A coming to bear of the seals B. However, such a seal assembly is only intended to accommodate one diameter of container A.

In one embodiment of the invention as shown in FIG. 2, the sphincter seal assembly comprises a seal unit (11) made up of 7 individual seal elements (12) which are supported within a housing in the form of sphincter barrel (13). The barrel (13) is supported within a framework (50) which is connected to a wall (52) which defines one wall of the glovebox, thereby separating the contaminated environment (54) from the clean environment (56).

Each of the seal elements (12) is a viton seal formed by a sheet of rubber (14) which is looped around a circular spring (15) made of spring steel. The viton seal being held in place by a pair of flanges, a seal ring (16) and a clamp ring (17), which tightly grip the rubber sheet (14) between them.

As shown in FIG. 3, these two flanges are clamped together by 6 M6 cap head screws (18) which engage with six pairs of corresponding holes in the seal ring and recesses in the clamp ring respectively.

Alignment of each pair of flanges is facilitated by 2 dowels (21) which rest in two pairs of corresponding recesses in the seal ring and clamp ring respectively as illustrated by FIG. 4.

In one embodiment of the invention the viton seal is looped around the spring (15) creating a through bore of 125 mm in diameter in the centre, in the relaxed state; the outer diameter of the viton seal being defined by the inner surfaces of the flanges and being 208 mm in diameter. The circular spring (15) can be stretched to vary the diameter of the through bore, as can the flexible rubber which is looped around it and forms the seal. The level of support offered by the circular spring (15) and the rubber sheet (14) is such that a container placed in the through bore will be effectively supported. No support structure to maintain the position of the container is needed, but there is no risk of the seal being unduly deformed and hence containment being breached.

The seven seals (12) are placed in series in the sphincter barrel (13) which may be made of stainless steel. The seal between the flanges (16, 17) and the sphincter barrel (13) is ensured by both the outer part (24) of the rubber sheet (14) of the viton seal (12) and the outer surfaces of the flanges (16, 17) contacting the inner surface (25) of the sphincter barrel (13). The seal elements (12) are prevented from falling out of the end (26) in the clean environment by a seal clamp (27) which is affixed to the sphincter barrel by means of 6 screws (28). This seal clamp can be removed and new seals placed into the sphincter barrel (13) as desired. Old seals are then allowed to simply drop into the contaminated glove box (54) at the contaminated environment end (31) for later disposal. A plate (60) is mounted on this end (31) during normal use to retain the seals (12) in place.

When it is desired to push a container into the glovebox and another container is to follow, then the second container is introduced into abutment with the first and the second is advanced to push the first through the seal and into the glovebox. The multiple seals ensure that no material from within the glovebox can leave during this operation. At all times when a container is not going to be followed by another into the glove box a plug (not shown) of a diameter which stretches the seals slightly is used. In the specific example given above a diameter 141 mm is used. A subsequent container may be posted into the glove box by pushing the plug into the glove box using the subsequent container, another plug or another container can be used to push the subsequent container into the glove box. The plug remains in the seal preventing breakage of the seal and release of contaminated material.

1. A seal assembly comprising a housing which defines a through bore, one or more seals being provided in the bore, one or more of the seals including a support frame, a seal element extending at least from the inner edge of the support frame to the boundary of a through aperture and one or more resiliently deformable members which at least partially surround the aperture in the seal element and which engage with the seal element, wherein the seal element is flexible and extends from the support frame, loops around and encloses the one or each resiliently deformable members and extends back to the support frame.

2. An assembly according to claim 1 in which the one or more seals support the weight of a container passing through the seal assembly.

3. An assembly according to claim 1 in which between four and ten such seals be provided.

4. An assembly according to claim 1 in which all of the seals present include a support frame, a seal element extending at least from the inner edge of the support frame to the boundary of a through aperture and one or more resiliently deformable members which at least partially surrounds the aperture in the seal element and which engage with the seal element, in which the seal element is flexible and extends from the support frame, loops around and encloses the one or each resiliently deformable member and extends back to the support frame.

5. An assembly according to claim 1 in which the support frame for the seal element includes a first frame component and a second frame component and at least apart of the seal element is sandwiched between the first and second frame components.

6. An assembly according to claim 1 in which the outer surface of the first and second components correspond to the internal profile of the housing.

7. An assembly according to claim 1 in which a series of seals whose support frames abut one another is provided.

8. An assembly according to claim 1 in which the seal element is formed of rubber.

9. An assembly according to claim 1 in which the one or more resiliently deformable members are springs.

10. An assembly according to claim 1 in which the member is a circular spring.

11. A passage between a first environment and a second environment in which the passage is sealed using a seal assembly according to claim 1.
